(19) United States
(12) Patent Application Publication
(10) Pub. No.: US 2025/0073515 A1
(43) Pub. Date: Mar. 6, 2025

(54) OXYGEN ENCAPSULATING AGENTS FOR FIREFIGHTING, USE AND METHOD OF PRODUCTION

(71) Applicant: COMBAT CHEMICALS LLC, ORLANDO, FL (US)

(72) Inventors: RODOLFO JORGE ERNESTO DE BEJAR FIORILO, TAUBATE (BR); PATRICIA FIORILO APRILE, SAO PAULO (BR)

(21) Appl. No.: 18/410,759

(22) Filed: Jan. 11, 2024

(30) Foreign Application Priority Data
Sep. 4, 2023 (BR) 1020230179444

(51) Int. Cl. A62D 1/00

(52) U.S. Cl. CPC A62D 1/0064

(57) ABSTRACT

Oxygen encapsulating agents, used to fight class A forest fires and rubber products (tires) that extinguish the fire by immediately cooling the materials, preventing their reignition and reducing toxic fumes from burning the treated materials, using phosphate products, particularly phosphate monoethanolamine, with the use of phosphoric ester additives, particularly the phosphoric ester of isotridecyl alcohol 6EO, resulting in a synergistic effect on fire suppression.

### TECHNICAL FIELD OF THE INVENTION

The following invention describes the development of products called oxygen encapsulating agents (EA), used to fight class A forest fires and rubber artifacts (tires) that extinguish the fire by immediately cooling the materials, preventing their reignition and reducing toxic fumes from burning the treated materials to a minimum.

### DESCRIPTION OF THE STATE OF THE ART

Oxygen encapsulating agents for firefighting are chemical substances designed to extinguish fires by reducing the oxygen content available in the environment. These agents work by encapsulating oxygen, preventing it from supporting combustion. This stops the chain reaction of the fire, extinguishing it or slowing its spread.

These agents are generally composed of chemical substances that can react with oxygen and form inert chemicals. This chemical reaction reduces the oxygen concentration in the environment, interrupting the combustion process.

There are different types of oxygen encapsulating agents used in firefighting. Some examples include:

Chemical powders: such as powders based on monoammonium phosphate (MAP), diammonium phosphate (DAP) and sodium bicarbonate. These powders react with oxygen and form inert compounds that suppress combustion.

Flame retardant liquids: such as water-based liquids with special additives that encapsulate oxygen, delaying the spread of fire.

Oxygen encapsulating aerosols: these are products in aerosol form that release particles that encapsulate oxygen into the environment, reducing its concentration and suppressing fire.

An example of aqueous droplets encapsulated in a flame-retardant polymer to suppress combustion is disclosed in U.S. Pat. No. 8,511,396. Upon exposure to a flame, the encapsulated aqueous droplets rupture and vaporize, removing heat and displacing oxygen to slow the combustion process. The polymer encapsulant, through decomposition, can also add free radicals to the combustion atmosphere, further delaying the combustion process. Encapsulated aqueous droplets can be used as a replacement for halon, water mist and dry powder flame suppression systems.

A biodegradable and non-toxic firefighting concentrate composition is disclosed in U.S. Pat. No. 5,945,026. Preferred compositions include 4 to 40 parts of a C16-C18 tertiary amine with 2-10 ethoxy or other solubilizing groups per mol, 1 to 15 parts of a carboxylic acid with 6 to 16 carbon atoms; 1 to 6 parts of a C6-C16 alcohol and 0 to 10 parts of C4-e lower alcohols and enough water to create a total of 100 parts by volume. The concentrate is normally diluted up to 100 times (v/v) with water and is also effective when mixed with foam-forming materials. Furthermore, the composition is useful with soil bacteria to remedy the soil contaminated with hydrocarbon fuel and to facilitate the dispersion and degradation of the fuel in bacterially acting sewage systems.

### Problems of the State of the Art

Oxygen encapsulating products used in firefighting are not applied to forest fires. This causes a major problem, because in this type of fire there is always the worry that the fire will reignite and cause a new fire, even in the place where the fire was supposed to have been extinguished.

The products currently on the market for firefighting are LGE (Foam Generating Liquids), which are mixtures of detergents with surfactants that, when they produce foam, smother the fire on the surface of the material, but the embers inside remain, which, in the presence of oxygen, again produce flames and restart the fire, forcing firefighters to do the aftermath, i.e. remove the extinguished material to find embers that will be put out.

### Proposed Solution

The subject of the present invention is new raw materials with new chemical compounds, with a particular method of using phosphate products with the addition of phosphoric ester additives that give a synergy of fire attack, acting as oxygen encapsulators and cooling effect of the internal ember.

The product will be used mainly, but not exclusively, to fight forest fires (fighting fires on the ground, underground and in the treetops) and Class A fires that occur in solid materials such as fabric, paper, cotton, rubber, and wood.

The product proposed in this invention has no limitations for use in firefighters' equipment, whether tank vehicles of any capacity for urban, rural or forestry use or fire trucks, as it is a liquid product.

The main novelty of the product developed is that it is a flame-retardant product that really puts out the fire and doesn't need any aftermath, as it doesn't allow any embers to remain. The developed product completely cools the burned material.

The product has the advantage of being an effective oxygen encapsulator, initially attacking the material on the surface, eliminating the oxygen present by extinguishing the fire and penetrating the inside of the material to cool and encapsulate the oxygen that may appear in the existing embers, preventing the embers from re-igniting. This way, there is no need to do the aftermath, making it easier and less time-consuming for firefighters and brigades to fight the fire. Cooling the material even allows the extinguished material to be removed manually without causing burns, which allows the fire to be attacked in other areas more effectively and quickly.

It is not a mixture of surfactants with carboxylic products, but a mixture of phosphoric esters with organic bonds.

### DETAILED DESCRIPTION OF THE INVENTION

The characterization of the invention disclosed is achieved by describing the steps necessary for the composition in question and the respective method of obtaining it, in such a way that it can be fully reproduced using an appropriate technique, allowing full characterization of the functionality of the claimed invention.

The description is based on the description of the quantities of the individual constituents that make up the product and its method of production, clarifying any aspects that may have been left out, in order to clearly determine the protection requested.

These steps may vary, if they do not deviate from what was initially required.

In this case, the product can be generated by different operations.

The main compounds involved are monoethanolamine phosphate and isotridecyl alcohol phosphoric ester 6EO. The IUPAC name of these compounds are orthophosphoric acid 2-aminoethanol and ethoxylated 6-mol isotridecyl alcohol. They are compounds with the following minimum formulas:
(R₁O)₃PO+(RO)₂PO(OH)+ROPO(OH)₂+H₂O

### Phosphate Phosphite Phosphonate

R₁=H₂N—CH₂CH₂OH (monoethanolamine) or replace with HN—(CH₂CH₂OH)₂ (diethanolamine) or with N—(CH₂CH₂OH)₃ (triethaneamines), where:
R=CH₃(CH₂)₁₀CHCH₃
O—(CH₂CH₂O)₆ (isotridecyl alcohol 6EO) or replace with n- or iso-alcohols from C8 to C20 with 2 to 20 EO (EO=ethylene oxide).

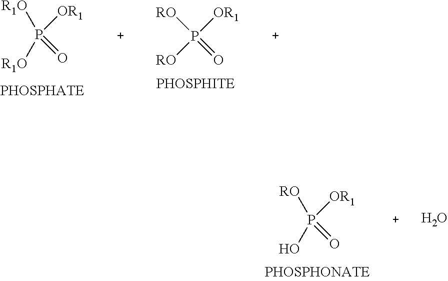

Product identity (concentration, toxicity, density, flammable or not, whether it exudes vapors, volatility and other information that allows the product to be characterized):
Aspect: Liquid;
Color: Slightly yellowish to yellow pH (sol 10%) 7 to 9;
Density: 1.20 g/ml;
Acidity level: 250 to 390 mg KOH/g;
Concentration 50 to 70%;
Toxicity: non-toxic;
Flammability: non-flammable;
Stability: non-volatile and does not emit vapors.

The product is liquid and will be packaged in 20 kg, 50 kg and 200 kg plastic drums, and in 1000 kg containers.

This invention relates to various possible reactions with the same effect based on the reaction of phosphoric acid with monoethanolamine, or diethanolamines or triethanolamine or with saturated and unsaturated C8 to C20 fatty amides, mixed with phosphoric esters of C8 to C20 fatty alcohols ethoxylated with 2 to 20 mol of ethylene oxide.

The field of organophosphate chemistry is increasing interest in the chemical industry. What supports new research and development efforts.

Inorganic phosphates and polyphosphates have been used to develop products in the field of oxygen encapsulators for use in extinguishing forest fires, type A fires and in rubber materials (tires).

Phosphorous organic compounds are also being used as additives to obtain cooling of fire-affected materials in Class A fires, forest fires and rubber fires (especially tires), along with oxygen encapsulating agents.

The production of phosphorous anionics containing surfactants as well as organophosphate derivatives will revolutionize the way of fighting fires that burn forests around the world with greater effectiveness compared to existing products.

Esters of phosphoric and polyphosphoric acids are the major segment of phosphorus-containing anionic surfactants used in the oxygen encapsulating product described here.

The main group are the primary, secondary and tertiary phosphorus hydroxylmethylamines (monoethanolamines, diethanolamines and triethanolamine phosphorus). Many of these products are aliphatic phosphate and polyphosphate alcohols. Another important group are phosphoric esters derived from ethoxylated alcohols and phenols.

Surfactants of saturated and unsaturated phosphate or polyphosphate C8 to C20 alcohols.

Of phosphoric esters of saturated and unsaturated ethoxylated C8 to C20 alcohols, as well as ethoxylated nonylphenols from 2 to 40 mol.

Our products based on this technology are concerned with reducing water pollution to the lowest possible effect on the environment by using organophosphorus surfactants that contain phosphorus and nitrogen molecules used in fertilizers.

This specification has the purpose of disclosing the use and production of phosphates and phosphoric esters to produce oxygen encapsulating agents.

The following description discloses the development of oxygen encapsulating products used to combat class A forest fires and rubber artifacts (tires) that extinguish the fire with immediate cooling of the material, preventing them from reigniting and reducing to minimum of toxic fumes from the burning of treated materials.

The reason for the present invention deals with new raw materials with new chemical compounds, with a particular method of using phosphate products, with the addition of phosphoric ester additives that give a fire attack synergy by acting as oxygen encapsulators and cooling effect of the internal ember.

### Method of Production

Use 15 to 27 parts of phosphoric acid added to 42 to 48 parts of monoethanolamine or replacing it with diethanolamine or triethanolamine and completed with 13 to 35 parts of water, with strong stirring.

Then add 8 to 12% of ADDITIVE I or II. Shake for 30 minutes and unload.

Methods of obtaining the additives that will be incorporated into the invention are:

### Additive I—Acid Phosphates and Polyphosphates

Phosphoric esters can be prepared by the esterification of aliphatic alcohols using phosphorus pentoxide or phosphorus oxychloride. Primary and secondary esters of orthophosphoric acids can be represented by the following formulas and structures:

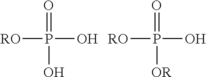

Alkyl dihydroxyl phosphate Dialkyl hydroxyl phosphate
(primary ester) (secondary ester)
R— is an aliphatic carbon from C8 to C20 (ROH in the form of alcohols).

Syntheses of primary and secondary acid phosphoric esters can be obtained in several ways.

The following are:
P₂O₅+4ROH→2 (RO)₂PO(OH)+H₂O
P₂O₅+2ROH+H₂O→2ROPO(OH)₂
P₂O₅+3ROH→(RO)₂PO(OH)+2ROPO(OH)₂

Where R is an aliphatic carbon from C8 to C20 (ROH in the form of alcohols).

The product of these reactions in the formation of primary and secondary esters depends on the amount of water formed during the reaction.

Molar ratios may vary from 1:2 to 1:4. The temperature at which the reaction takes place determines the reaction rate, but not the composition of the product.

Reactions between aliphatic alcohols and phosphorus oxychloride also give mono- and diesters.
ROH+POCL₃→ROPOCL₂+HCL
ROPOCL₂+2H₂O→ROPO(OH)₂+2HCL
2ROH+POCL₃→(RO)₂POCL+2HCL
(RO)₂POCL+H₂O→(RO)₂POH+2HCL

Where R is an aliphatic carbon from C8 to C20 (ROH in the form of alcohols) and the most used are detailed below.

The additive I to be used is the reaction between phosphorus pentoxide and the most commonly used alcohols, represented by R in the formula, which are caprylic (octyl, iso-octyl, 2 ethyl hexanol, dimethyl hexyl), capric (n-decyl, isodecyl, dimethyl octyl, trimethyl hexyl), lauric (dodecyl, iso-dodecyl, trimethyl nonyl), tridecyl and iso-tridecyl, myristic, palmitic (hexadecyl, cetyl, cetyl stearyl), stearic (C18), oleic (C18-1), arachidic (C20) and eicosyl (C20-1) alcohols.

Method of obtaining the additive I most used as an example in the product that is the reason for this patent.

React 1 mol of phosphorus pentoxide by adding 3 to 6 mol of octyl alcohol for 60 minutes, at room temperature with strong stirring, and heated between 10° and 120° C. for 5 hours and then cooled.

### Additive II—Polyoxyalkylene Phosphoric Esters

The raw materials most used for phosphorylation reactions are ethoxylated long-chain aliphatic alcohols and ethoxylated alkylphenols.

Phosphoric polyoxyalkylene monos and diesters have the following structures:

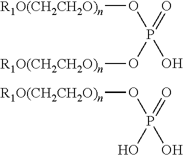

In most cases, aliphatic, cycloaliphatic, and aliphatic-aromatic alcohols are first treated with ethylene oxides and/or polypropylene oxides (block) or mixtures of both (blend) following the reaction with P₂O₅, POCl₃, H₃PO₄ or acids polyphosphoric.

Additive II to be used will be the reaction between phosphorus pentoxide and the most commonly ethoxylated alcohols, represented in the formula as R₁O, used on the market which are the following alcohols 2 ethyl hexanol 2 EO, n-decyl 30 EO, iso-decyl from 3 to 8 EO, lauric from 2 to 10 EO, tridecyl from 3 to 15 EO, isotridecyl from 3 to 15 EO, cetyl from 2 to 20 EO, cetylstearyl) stearyl from 2 to 20 EO and oleic from 2 to 20 EO.

Method of obtaining additive II most used as an example in the product that is the subject of this patent.

React 1 mol of phosphorus pentoxide by adding 3 to 6 mol of iso-tridecyl alcohol with 6 mol of ethylene oxide for 60 minutes, at room temperature, with strong stirring and heated between 10° and 120° C. for 5 hours then cooled.

If it is necessary to use colorants, they might need to be approved by the regulatory agencies as food colorants.

There are 8 artificial colors permitted for food use which are listed: twilight yellow, brilliant blue, Bordeaux S or amaranth, erythrosine, indigotine, ponceau 4R, tartrazine and red 406. Use two parts of the dye for 100 parts of the product.

### Method of Production of the Main Product

The present invention will be produced with the following formulation and method to be cited here but may also be used with other raw materials mentioned above. Many examples can be given using various raw materials that the invention may use to be determined by following this process and method.

The following components will be added and mixed in the following proportion to complete the proposed reaction.

Under constant stirring, use 25 parts of phosphoric acid, 46 parts of monoethanolamine (MEA), 20 parts of water and 9 parts of ADDITIVE II (Acid phosphoric ester of isotridecyl alcohol 6EO (6 mol ethylene oxide, 1:3 ratio). At the end, stir for 30 minutes and drain, if necessary, add two parts of food coloring at the end of stirring and homogenize.

### Method of Use in Forest Fires, Type A and Rubber Materials

The product described above, for use in fighting type A forest fires and on rubber materials, can be used in solutions of 3 and 6% in water with which the fire will be put out quickly.

In pasture areas, 10 to 25% water solutions can be used to extinguish the fire more quickly. The product also drastically reduces toxic smoke, allowing fire brigades to work over a larger firefighting area. The applied solutions of the product act as oxygen encapsulators on the surface of the materials, extinguishing the fire immediately within 30 seconds and penetrating the inside of the extinguished material, cooling it to less than 30° C. and eliminating the existing embers, which eliminates the re-ignition of the material, as well as allowing the manual removal of the extinguished material if necessary, without the problem of causing burns.

The consumption of 3% solutions is 8 to 30 times lower, depending on the material extinguished, compared to LGE products (foam-generating liquids), which generates considerable water savings when fighting fires.

Solutions stored after a certain time may suffer bacterial attacks, but the effect of putting out the fire remains for up to 6 months.

The pure product does not suffer from bacterial attack and the shelf life is 5 years, including after being used and keeping the packaging tightly closed.

The product preserves the flora with rapid soil recovery because it contains phosphorus and nitrogen components, used in fertilizers, which are necessary for plants, preserving the environment, protects the fauna because the solutions used are not toxic and do not contain heavy metals that could affect animal life and do not contaminate river water or the like.

1. Oxygen encapsulating agents, characterized by using phosphate products, particularly monoethanolamine phosphate, with the use of phosphoric ester additives, particularly the phosphoric ester of isotridecyl alcohol 6EO, resulting in a synergistic effect on fire suppression.

2. Oxygen encapsulating agents, in accordance with claim 1 and characterized by said additive I to be used is obtained from the reaction between phosphorus pentoxide and the alcohols represented by R in the formula, which are caprylic alcohols (octyl, iso-octyl, 2 ethyl hexanol, dimethyl hexyl), capric (n-decyl, isodecyl, dimethyl octyl, trimethyl hexyl), lauric (dodecyl, iso-dodecyl, trimethyl nonyl), tridecyl and iso-tridecyl, myristic, palmitic (hexadecyl, cetyl, cetylstearyl) stearic (C18), oleic (C18-1), arachidic (C20) and eicosyl (C20-1).

3. Oxygen encapsulating agents, in accordance with claim 1 and characterized by said additive II to be used, is obtained from the reaction between phosphorus pentoxide and ethoxylated alcohols, represented in the formula as R₁O, which are alcohols 2 ethyl hexanol 2 EO, n-decyl 30 EO, iso-decyl 3 to 8 EO, lauric 2 to 10 EO, tridecyl 3 to 15 EO, isotridecyl 3 to 15 EO, cetyl 2 to 20 EO, cetylstearyl) stearyl 2 to 20 EO and oleic from 2 to 20 EO.

4. Method of production of said additives as disclosed in claim 1 and characterized by:
production of the additive I consist of reacting 1 mol of phosphorus pentoxide adding 3 to 6 mol of octyl alcohol for 60 minutes, at room temperature with strong stirring, heating between 10° and 120° C. for 5 hours and then cooled; and
obtaining additive II consists of reacting 1 mol of phosphorus pentoxide by adding 3 to 6 mol of iso-tridecyl alcohol with 6 mol of ethylene oxide for 60 minutes, at room temperature, with strong stirring, with heating between 10° and 120° C. for 5 hours and then cooled.

5. Method of production of oxygen encapsulating agents as disclosed in claim 1, characterized by:
use of 15 to 27 parts of phosphoric acid added to 42 to 48 parts of monoethanolamine or replacing it with diethanolamine or triethanolamine and completed with 13 to 35 parts of water, with strong stirring, and
adding 8 to 12% of additive I or II, shake for 30 minutes and unload.

6. Method of production of oxygen encapsulating agents as disclosed in claim 1, characterized by:
under constant stirring, use of 25 parts of phosphoric acid, 46 parts of monoethanolamine (MEA), 20 parts of water and 9 parts of additive II;
shaking for 30 minutes and draining, and
optionally adding two parts of food coloring at the end of stirring and homogenize.
